(19) United States
(12) Patent Application Publication
(10) Pub. No.: US 2026/0166407 A1
(43) Pub. Date: Jun. 18, 2026

(54) METHOD AND SYSTEM FOR PROVIDING INFORMATION ON GOLF BALLS

(71) Applicant: CREATZ INC., Suwon-si Gyeonggi-do (KR)

(72) Inventors: Dong Wan HAN, Seoul (KR); Jungbeom HWANG, Seoul (KR)

(73) Assignee: CREATZ INC., Suwon-si Gyeonggi-do (KR)

(21) Appl. No.: 19/532,280

(22) Filed: Feb. 6, 2026

Related U.S. Application Data
(63) Continuation of application No. PCT/KR2024/011447, filed on Aug. 2, 2024.

(30) Foreign Application Priority Data
Aug. 9, 2023 (KR) 10-2023-0104468

(51) Int. Cl. A63B 69/36; A63B 71/06

(52) U.S. Cl. CPC A63B 69/3667; A63B 71/0622; A63B 2220/13; A63B 2220/56; A63B 2220/89; A63B 2225/20

(57) ABSTRACT

According to one aspect of the present invention, there is provided a method for providing information on golf balls, the method comprising the steps of: acquiring at least one of first information on at least one of positions and directions of feet and second information on a position of a golf ball; and generating third information on a posture associated with a golf swing with reference to at least one of the first information and the second information.

### CROSS-REFERENCE TO RELATED APPLICATION(S)

This application is a continuation of Patent Cooperation Treaty (PCT) International Application No. PCT/KR2024/011447 filed on Aug. 2, 2024, which claims priority to Korean Patent Application No. 10-2023-0104468 filed on Aug. 9, 2023. The entire contents of PCT International Application No. PCT/KR2024/011447 and Korean Patent Application No. 10-2023-0104468 are hereby incorporated by reference.

### FIELD OF THE INVENTION

The present invention relates to a method and system for providing information on golf balls.

### BACKGROUND

Golf industries are rapidly growing as public interest in golf has recently increased, and various techniques for estimating information associated with golf swings are being developed.

Since golf is a sport in which a golfer supports himself/herself on the ground with both feet and strikes a golf ball with a golf club, a relationship between the positions and directions of the feet and the position of the golf ball significantly affects the outcome of the golf swing.

One example of conventional methods for estimating a posture associated with a golf swing is to analyze a golf swing of a user by photographing a flight trajectory of a golf ball. However, this method does not consider a relative position relationship between the user's feet and the golf ball during the golf swing, and has a problem of being unable to provide the user with appropriate feedback according to the ball's position.

In this connection, the inventor(s) present a technique for assisting in placing both feet of a user and a golf ball in optimal positions during a golf swing by acquiring at least one of information on at least one of positions and directions of the feet and information on a position of the ball, and generating information on a relative position relationship between the feet and the ball.

### SUMMARY OF THE INVENTION

One object of the present invention is to solve all the above-described problems in the prior art.

Another object of the invention is to acquire at least one of first information on at least one of positions and directions of feet and second information on a position of a golf ball, and generate third information on a posture associated with a golf swing with reference to at least one of the first information and the second information.

Another object of the invention is to assist in placing both feet of a user and a golf ball in optimal positions during a golf swing.

Another object of the invention is to assist a user in adjusting a position of a golf ball by generating feedback information on the position of the golf ball.

The representative configurations of the invention to achieve the above objects are described below.

According to one aspect of the invention, there is provided a method comprising the steps of: acquiring at least one of first information on at least one of positions and directions of feet and second information on a position of a golf ball; and generating third information on a posture associated with a golf swing with reference to at least one of the first information and the second information.

According to another aspect of the invention, there is provided a system comprising: an information acquisition unit configured to acquire at least one of first information on at least one of positions and directions of feet and second information on a position of a golf ball; and a posture information generation unit configured to generate third information on a posture associated with a golf swing with reference to at least one of the first information and the second information.

In addition, there are further provided other methods and systems to implement the invention, as well as non-transitory computer-readable recording media having stored thereon computer programs for executing the methods.

According to the invention, it is possible to acquire at least one of first information on at least one of positions and directions of feet and second information on a position of a golf ball, and generate third information on a posture associated with a golf swing with reference to at least one of the first information and the second information.

According to the invention, it is possible to assist in placing both feet of a user and a golf ball in optimal positions during a golf swing.

According to the invention, it is possible to assist a user in adjusting a position of a golf ball by generating feedback information on the position of the golf ball.

### B RIEF DESCRIPTION OF THE DRAWINGS

FIG. 1 schematically shows the configuration of an entire system for providing information on golf balls according to one embodiment of the invention.

FIG. 2 specifically shows the internal configuration of an information provision system according to one embodiment of the invention.

FIG. 3 illustratively shows a situation in which third information on a posture associated with a golf swing is provided according to one embodiment of the invention.

FIG. 4 illustratively shows a situation in which first reference coordinate information and second reference coordinate information are synchronized according to one embodiment of the invention.

### DESCRIPTION OF THE REFERENCE NUMERALS

100: communication network
200: information provision system
210: information acquisition unit
220: posture information generation unit
230: feedback information generation unit
240: communication unit
250: control unit
300: device
410: first reference coordinates
420: second reference coordinates
430: third reference coordinates

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

The term “golf swing” as used herein may refer to a swing motion for sending a golf ball to a target point. Here, a golf swing may be composed of eight steps of partial motions such as an address, a takeaway, a back swing, a top-of-swing, a down swing, an impact, a follow-through, and a finish. However, the eight steps of partial motions are merely illustrative, and it will be apparent to those skilled in the art that the golf swing motion may be separated in a variety of ways.

### Configuration of the Entire System

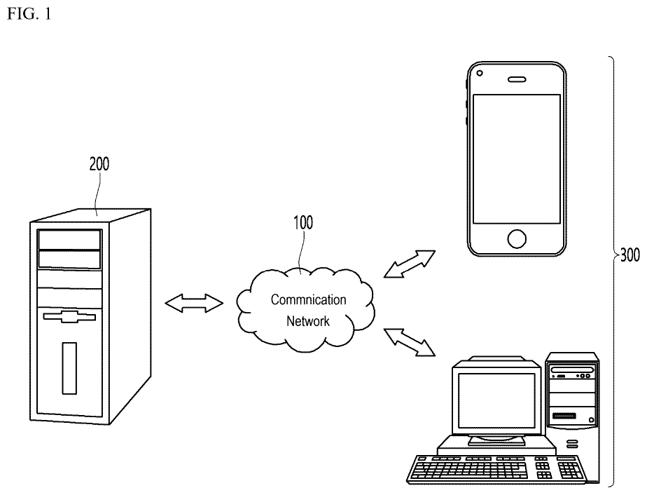

FIG. 1 schematically shows the configuration of the entire system for providing information on golf balls according to one embodiment of the invention.

As shown in FIG. 1, the entire system according to one embodiment of the invention may comprise a communication network 100, an information provision system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the information provision system 200 according to one embodiment of the invention may function to acquire at least one of first information on at least one of positions and directions of feet and second information on a position of a golf ball, and generate third information on a posture associated with a golf swing with reference to at least one of the first information and the second information.

The configuration and functions of the information provision system 200 according to the invention will be discussed in more detail below.

Next, the device 300 according to one embodiment of the invention is digital equipment capable of connecting to and then communicating with the information provision system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the functions according to the invention from the information provision system 200. The application may be downloaded from the information provision system 200 or an external application distribution server (not shown). Meanwhile, the characteristics of the application may be generally similar to those of an information acquisition unit 210, a posture information generation unit 220, a feedback information generation unit 230, a communication unit 240, and a control unit 250 of the information provision system 200 to be described below. Here, at least a part of the application may be replaced with a hardware device or a firmware device that may perform a substantially equal or equivalent function, as necessary.

### Configuration of the Information Provision System

Hereinafter, the internal configuration of the information provision system 200 crucial for implementing the invention and the functions of the respective components thereof will be discussed.

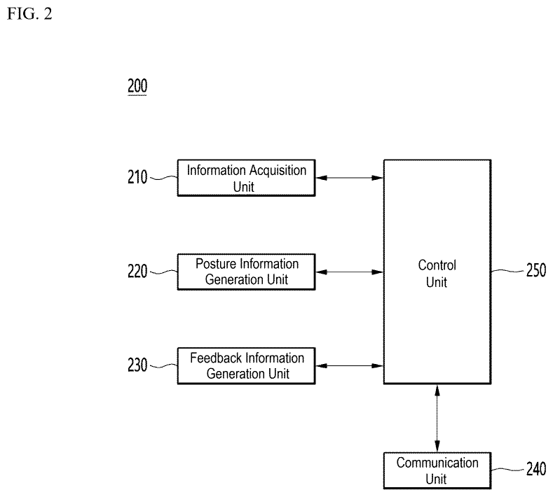

FIG. 2 specifically shows the internal configuration of the information provision system 200 according to one embodiment of the invention.

As shown in FIG. 2, the information provision system 200 according to one embodiment of the invention may comprise an information acquisition unit 210, a posture information generation unit 220, a feedback information generation unit 230, a communication unit 240, and a control unit 250. According to one embodiment of the invention, at least some of the information acquisition unit 210, the posture information generation unit 220, the feedback information generation unit 230, the communication unit 240, and the control unit 250 may be program modules to communicate with an external system (not shown). The program modules may be included in the information provision system 200 in the form of operating systems, application program modules, and other program modules, while they may be physically stored in a variety of commonly known storage devices. Further, the program modules may also be stored in a remote storage device that may communicate with the information provision system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the information provision system 200 has been described as above, and it will be apparent to those skilled in the art that at least a part of the components or functions of the information provision system 200 may be implemented in the device 300 or a server (not shown) or included in an external system (not shown), as necessary.

First, the information acquisition unit 210 according to one embodiment of the invention may function to acquire at least one of first information on at least one of positions and directions of feet and second information on a position of a golf ball.

Specifically, the first information according to one embodiment of the invention may include information on at least one of positions and directions of feet. Here, the information on the positions of the feet according to one embodiment of the invention may be acquired by a sensor detecting coordinates of two feet of a user, and may be acquired for each of the left foot and the right foot. Further, the information on the directions of the feet according to one embodiment of the invention may be acquired by the sensor detecting a direction of each of the left foot and right foot of the user.

Further, the second information according to one embodiment of the invention may include information on a position of a golf ball. Here, the information on the position of the golf ball according to one embodiment of the invention may be acquired by the sensor detecting coordinates of the position of the ball.

For example, at least one of the first information and the second information according to one embodiment of the invention may be acquired from at least one pressure sensor that may be placed on the ground.

As a specific example, according to one embodiment of the invention, the two feet of the user and the golf ball may be positioned on a mat. Here, the mat according to one embodiment of the invention may include at least one pressure sensor placed on the ground. Further, according to one embodiment of the invention, the information acquisition unit 210 may acquire the first information on at least one of the positions and directions of the feet by the at least one pressure sensor measuring ground pressure corresponding to gravity acting on the two feet of the user. Further, according to one embodiment of the invention, the information acquisition unit 210 may acquire the second information on the position of the golf ball by the at least one pressure sensor measuring ground pressure corresponding to gravity acting on the golf ball.

Meanwhile, the pressure sensor according to one embodiment of the invention may detect a specific point within an area where a foot contacts the ground as the position of the foot, but may also detect the entire area where the foot contacts the ground as the position of the foot. Therefore, the information acquisition unit 210 according to one embodiment of the invention may acquire information on a specific point (e.g., heel) within the area where the foot contacts the ground as the first information, as well as acquire information on the entire area where the foot contacts the ground as the first information.

Further, according to one embodiment of the invention, at least one of the first information and the second information may also be acquired from an image sensor.

For example, according to one embodiment of the invention, at least one of the first information and the second information may be acquired by photographing an image at a specific point of time while the user is performing (or preparing for) a golf swing.

As another example, according to one embodiment of the invention, at least one of the first information and the second information may be acquired by photographing a video from a point of time when it is determined that the user stops for the golf swing (e.g., when an address begins) to a point of time when it is determined that the golf ball is struck (e.g., a time of impact).

Meanwhile, according to one embodiment of the invention, the first information and the second information may be acquired from a single sensor. For example, according to one embodiment of the invention, both the first information and the second information may be acquired from a single pressure sensor placed on the ground. Further, according to one embodiment of the invention, both the first information and the second information may be acquired from a single image sensor (e.g., a camera).

In addition, the information acquisition unit 210 according to one embodiment of the invention may acquire at least one of the first information and the second information in response to at least one of determining that the user's posture is stopped for the golf swing, and determining that the golf ball is struck.

For example, assuming a situation in which the user is in a stationary state at a teeing area to perform a golf swing (e.g., when an address phase begins), there may be a point of time when it is determined that a degree of change in at least one of the positions and directions of the user's feet is not greater than a predetermined reference value, in which case it may be determined that the user's posture is stopped for the golf swing. Here, the information acquisition unit 210 according to one embodiment of the invention may acquire at least one of the first information and the second information corresponding to that point of time.

As another example, assuming a situation in which the user strikes a golf ball with a golf club (i.e., a situation of impact of the golf ball), there may be a point of time when it is determined that the golf ball is started to move, in which case it may be determined that the golf ball is struck. Here, the information acquisition unit 210 according to one embodiment of the invention may acquire at least one of the first information and the second information corresponding to that point of time.

Meanwhile, according to one embodiment of the invention, at least one of whether the user's posture is stopped for the golf swing and whether the golf ball is struck may be determined with reference to information acquired by at least one sensor among at least one pressure sensor that may be placed on the ground, an image sensor, and a sound sensor (e.g., a sound sensor capable of detecting sound from striking the golf ball at impact).

Further, according to one embodiment of the invention, the information acquisition unit 210 may determine at least one of whether the user's posture is stopped for the golf swing and whether the golf ball is struck. However, such determination may also be performed by a component of the information provision system 200 other than the information acquisition unit 210, or by an external system.

Next, the posture information generation unit 220 according to one embodiment of the invention may function to generate third information on a posture associated with a golf swing with reference to at least one of the first information and the second information.

Specifically, the third information according to one embodiment of the invention may include information on a distance between a point that is the center of the left foot's position and the right foot's position (i.e., the center point between the two feet) and the position of the golf ball.

Further, the third information according to one embodiment of the invention may include information on a distance between a virtual straight line that passes through the point that is the center of the left foot's position and the right foot's position and is perpendicular to an aiming direction toward a target (e.g., a virtual straight line extending from the center point between the two feet in a direction toward the user's abdomen) and the golf ball.

Furthermore, the third information according to one embodiment of the invention may also include information on a distance between the left foot's position and the right foot's position.

Moreover, the third information according to one embodiment of the invention may also include information on an angle formed between a virtual straight line passing through the left foot's position and the right foot's position and the aiming direction toward the target.

In addition, the third information according to one embodiment of the invention may include information on a relative position of the golf ball with respect to the left foot's position (or the right foot's position). For example, the third information according to one embodiment of the invention may include information on a distance between a virtual straight line extending from the left foot's position in a direction toward the abdomen and the golf ball.

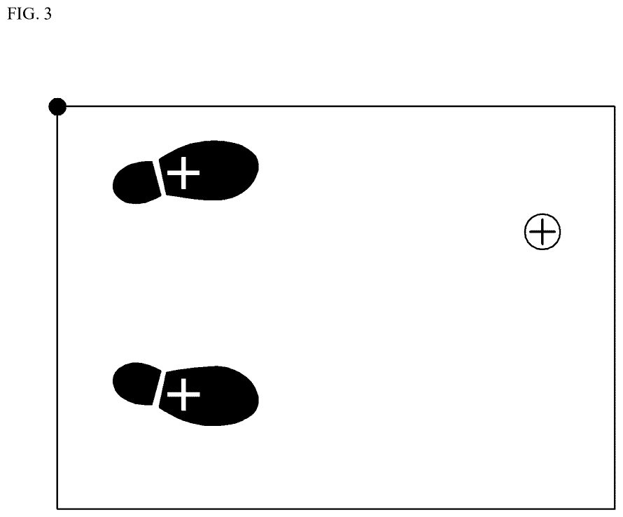

FIG. 3 illustratively shows a situation in which the third information on the posture associated with the golf swing is provided according to one embodiment of the invention.

Referring to FIG. 3, the third information according to one embodiment of the invention may include information on a relative position relationship between the feet and the golf ball determined with reference to the first information and the second information.

For example, referring to FIG. 3 for explanation, the third information according to one embodiment of the invention may include information indicating that when a virtual straight line extending from the center point between the two feet in a direction toward the user's abdomen (hereinafter, “reference straight line”) is compared with the position of the golf ball, the golf ball is biased to the left with respect to the direction toward the user's abdomen compared to the reference straight line.

As another example, referring to FIG. 3 for explanation, the third information according to one embodiment of the invention may include information indicating that the golf ball is positioned at a point 15 cm to the left of the reference point (i.e., information on a relative position of the golf ball with respect to the feet's positions).

According to one embodiment of the invention, when the first information and the second information are acquired from the same sensor (e.g., a pressure sensor placed on the ground or a camera sensor), coordinate components associated with one coordinate system are detected to acquire the first information and the second information, so that coordinate information may not need to be separately synchronized during the process of generating the third information. However, when the first information and the second information according to one embodiment of the invention are respectively acquired from different sensors, a process of synchronizing reference coordinate information of the first information and the second information may be necessary.

Therefore, the posture information generation unit 220 according to one embodiment of the invention may also function to synchronize first reference coordinate information included in the first information and second reference coordinate information included in the second information.

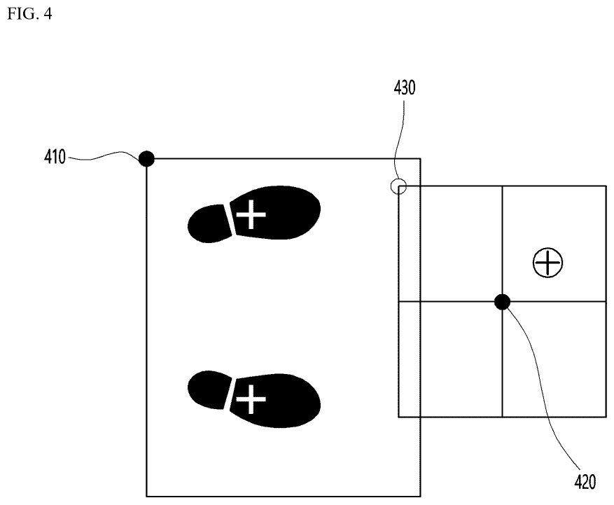

FIG. 4 illustratively shows a situation in which the first reference coordinate information and the second reference coordinate information are synchronized according to one embodiment of the invention.

Referring to FIG. 4, according to one embodiment of the invention, it may be assumed that the first information is acquired from a pressure sensor that may be placed on the ground, and the second information is acquired from a camera sensor.

Here, for example, the posture information generation unit 220 according to one embodiment of the invention may synchronize information on first reference coordinates 410 included in the first information and information on second reference coordinates 420 included in the second information.

As another example, the posture information generation unit 220 according to one embodiment of the invention may specify the information on the first reference coordinates 410 included in the first information, and specify the information on the second reference coordinates 420 included in the second information (e.g., information on coordinates corresponding to a specific area of an image or video acquired from the camera sensor). Then, the posture information generation unit 220 according to one embodiment of the invention may synchronize the first reference coordinates 410 and third reference coordinates 430, and synchronize the second reference coordinates 420 and the third reference coordinates 430, thereby finally synchronizing the first reference coordinates 410 and the second reference coordinates 420.

Next, the feedback information generation unit 230 according to one embodiment of the invention may function to generate feedback information on a result of comparing the third information with pre-stored position information.

Specifically, the pre-stored position information according to one embodiment of the invention may include at least one of guide information on a distance between the center point between the two feet and the position of the golf ball, guide information on a distance between the reference straight line and the golf ball, guide information on a distance between the two feet, and guide information on an angle formed by a virtual straight line connecting the two feet and the aiming direction toward the target.

For example, referring to FIG. 4, it may be assumed that the pre-stored position information according to one embodiment of the invention includes information indicating that the golf ball is positioned on the reference straight line. Here, the feedback information generation unit 230 according to one embodiment of the invention may generate feedback information including information indicating that the position of the golf ball should be changed to the right.

Meanwhile, the pre-stored position information according to one embodiment of the invention may be generated with reference to at least one of the first information and the second information acquired during the user's past golf swings. In this case, the feedback information generation unit 230 according to one embodiment of the invention may provide statistical information associated with the user's golf swing history from a specific past point of time to the current point of time as the feedback information. For example, the feedback information generation unit 230 according to one embodiment of the invention may refer to the third information to provide statistical information on golf swings at relative positions of the golf ball with respect to specific positions of the feet as the feedback information. As a specific example, the feedback information generation unit 230 according to one embodiment of the invention may generate feedback information including information indicating that, when a golf swing is performed at the current relative position of the golf ball with respect to the two feet, a probability of making a birdie is 60% according to the user's past golf swing statistics.

According to one embodiment of the invention, various factors may influence a result of a golf swing, such as a type of golf club, information on terrain where the golf swing is performed (e.g., slope or course composition (fairway, bunker, hazard, and the like)), and weather information (e.g., temperature, humidity, and the like).

Therefore, the information acquisition unit 210 according to one embodiment of the invention may further acquire situation information (e.g., information on a golf club currently used by the user, information on terrain where the golf swing is performed, or weather information). Here, the situation information according to one embodiment of the invention may be acquired from a system external to the information provision system 200, but may also be acquired from at least one sensor. Further, the situation information according to one embodiment of the invention may include at least one of information on the user's physical condition (e.g., height, arm length, and leg length), a difficulty level of a golf club being used by the user (e.g., beginner club, intermediate club, or advanced club), and a type of shot that the user intends to execute (e.g., draw shot, fade shot, or straight shot).

Further, the posture information generation unit 220 according to one embodiment of the invention may generate the third information on the posture associated with the golf swing with further reference to the situation information.

In addition, the pre-stored position information according to one embodiment of the invention may further include situation guide information.

Hereinafter, it will be described by way of example how feedback information according to one embodiment of the invention is generated in association with the situation guide information.

### First Embodiment

It may be assumed that the third information according to one embodiment of the invention includes information indicating that the user is taking a swing stance using a 7-iron on fairway terrain with a slope angle of 5 degrees (e.g., an uphill slope where the left foot is higher than the right foot), and a relative position of the ball with respect to the two feet is at a point 10 cm to the right of the reference straight line, and that the situation guide information according to one embodiment of the invention includes information indicating that, when using a 7-iron on fairway terrain with a slope angle of 5 degrees (e.g., an uphill slope where the left foot is higher than the right foot), the relative position of the ball with respect to the two feet should be on the reference straight line.

Here, the feedback information generation unit 230 according to one embodiment of the invention may generate feedback information including information indicating that the position of the golf ball should be moved 10 cm to the left.

Therefore, according to the invention, the user may be provided with appropriate feedback on ball positions corresponding to various golf swing environments.

### Second Embodiment

According to one embodiment of the invention, the information acquisition unit 210 may acquire the first information on the positions of the feet and the second information on the position of the golf ball, and may further acquire information indicating that the golf club being used by the user is a driver (i.e., situation information).

Further, according to one embodiment of the invention, the posture information generation unit 220 may generate third information indicating that the user is taking a swing stance using a driver, and the golf ball is positioned 10 cm to the right with respect to a virtual straight line extending from the left foot's position in a direction toward the user's abdomen.

Here, assuming that the situation guide information according to one embodiment of the invention includes information indicating that, when taking a swing stance using a driver, the golf ball should be positioned on the virtual straight line extending from the left foot's position in the direction toward the abdomen, the feedback information generation unit 230 according to one embodiment of the invention may generate feedback information including information indicating that the position of the golf ball should be moved 10 cm to the left.

Next, the communication unit 240 according to one embodiment of the invention may function to enable data transmission/reception from/to the information acquisition unit 210, the posture information generation unit 220, and the feedback information generation unit 230.

Lastly, the control unit 250 according to one embodiment of the invention may function to control data flow among the information acquisition unit 210, the posture information generation unit 220, the feedback information generation unit 230, and the communication unit 240. That is, the control unit 250 according to one embodiment of the invention may control data flow into/out of the information provision system 200 or data flow among the respective components of the information provision system 200, such that the information acquisition unit 210, the posture information generation unit 220, the feedback information generation unit 230, and the communication unit 240 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for providing information on golf balls, the method comprising the steps of:
acquiring at least one of first information on at least one of positions and directions of feet and second information on a position of a golf ball; and
generating third information on a posture associated with a golf swing with reference to at least one of the first information and the second information.

2. The method of claim 1, wherein at least one of the first information and the second information is acquired from at least one pressure sensor capable of being placed on a ground.

3. The method of claim 1, wherein at least one of the first information and the second information is acquired from an image sensor.

4. The method of claim 1, wherein in the generating step, first reference coordinate information included in the first information and second reference coordinate information included in the second information are synchronized.

5. The method of claim 1, further comprising the step of:
generating feedback information on a result of comparing the third information with pre-stored position information.

6. The method of claim 1, wherein in the acquiring step, the first information and the second information are acquired from a single sensor.

7. A non-transitory computer-readable recording medium having stored thereon a computer program for executing the method of claim 1.

8. A system for providing information on golf balls, the system comprising:
an information acquisition unit configured to acquire at least one of first information on at least one of positions and directions of feet and second information on a position of a golf ball; and
a posture information generation unit configured to generate third information on a posture associated with a golf swing with reference to at least one of the first information and the second information.

9. The system of claim 8, wherein at least one of the first information and the second information is acquired from at least one pressure sensor capable of being placed on a ground.

10. The system of claim 8, wherein at least one of the first information and the second information is acquired from an image sensor.

11. The system of claim 8, wherein the posture information generation unit is configured to synchronize first reference coordinate information included in the first information and second reference coordinate information included in the second information.

12. The system of claim 8, further comprising:
a feedback information generation unit configured to generate feedback information on a result of comparing the third information with pre-stored position information.

13. The system of claim 8, wherein the information acquisition unit is configured to acquire the first information and the second information from a single sensor.
